(19) United States
(12) Patent Application Publication
(10) Pub. No.: US 2006/0266292 A1
(43) Pub. Date: Nov. 30, 2006

(54) INSECT CONTAINER

(76) Inventor: William James Duckworth, LACOMBE (CA)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 10/908,928

(22) Filed: Jun. 1, 2005

(30) Foreign Application Priority Data
May 30, 2005 (CA) INSECT CONTAINER

(51) Int. Cl. A01K 29/00

(52) U.S. Cl. 119/6.5

(57) ABSTRACT

An insect container has a bottom, side walls, and a top, and an internal divider for dividing the container into sections. The internal divider has a gap for permitting movement of an insect from section to section. The container has perforations in the side walls to provide traction and ventilation for insects within the container. The container has a closable insect removal opening in the top, and the closable insect removal opening is locatable over any section of the container. The insect container is suitable for shipping, selling, and storing a variety of live insects, such as crickets.

### BACKGROUND OF THE INVENTION

In the pet industry, insects, such as crickets, are a common source of food for snakes, lizards, tarantulas, and other pets. Typically, the insects are supplied to pet stores in large numbers. Once in the pet store, the insects are stored in bins provided with food, water, and typically some sort of material on which to crawl and climb, such as egg carton flats. In this arrangement, it is common for insects, particularly jumping insects such as crickets, to escape from the bin. Also, it is difficult to assess the health of the insects once they are placed in the bins. Some insects, such as crickets, will tend to cannibalize their weaker counterparts, and the storage method tends to have a high die-off rate.

Removal of the insects in the pet store is also inefficient. The pet owner wanting to buy a dozen insects must find a clerk to remove the insects from the bin. Because the insects jump and crawl about randomly, it is difficult to provide the pet owner with an accurate number of insects. Clerks tend to scoop into the bin, remove far more than the required number, and place them in a paper bag or similar container to give to the pet owner. For the pet store, the cost of giving the pet owner twice what he wants, or possibly more, can become expensive. At roughly 10 cents an insect, the equivalent of dollars a day can easily be given away due to inattention, inexperience, or indifference on the part of the clerk.

The pet owner, left holding the bag, must now return home to feed his pet. Some insects, such as crickets, are voracious eaters and will chew on anything that lends itself to being eaten. Paper and cardboard are easily chewed on and through by crickets, for example. Therefore, the pet owner must either dump all the insects into the terrarium or other enclosure holding his pet, or find some other container in which to store them. Dumping all the insects into the terrarium can be problematic because the pet may not require all the insects to be fed fully, leaving the rest of the insects to hop and crawl about, with the potential that the insects will escape from the enclosure and get into the house. If the pet owner decides to dump only some in, he must find a container in which to store the remainder.

Many pet owners have neither the time nor the inclination to fashion a container suitable for the purpose of storing insects until such time as they are needed for feeding to the pet. Likewise, the same problems present in storing the insects in bins can arise in placing the insects into a container fashioned at home. If the pet owner has been sold a great excess of insects to the number actually required, the problems could be aggravated, with the insects tending to get sick and to devour weaker counterparts on a greater scale, due to the lack of space in the container.

Because of these difficulties, many pet owners find themselves driving to the pet store several times a week to purchase a minimal number of insects, thus expending time, using gas, and putting wear and tear on their vehicle, all for the sake of feeding their pet a few insects on a regular basis.

### SUMMARY OF THE INVENTION

There is therefore provided an insect container that simplifies the purchase of insects from a pet store, that permits storage of the insects for an extended period of time, that allows assessment of the health and vitality of the insects in a quick and easy fashion, and that prevents the insects from escaping prior to being fed to a pet.

The insect container comprises a bottom, a top, and side walls connecting between the bottom and the top, the bottom of the container being impervious to insects, internal dividing walls separating the container into three or more sections, the internal dividing walls extending between the top and the bottom of the container, each internal dividing wall separating a pair of adjacent sections, and the top incorporating a closable opening that is locatable over any one of the sections.

These and other aspects of the invention are set out in the claims, which are incorporated here by reference.

### BRIEF DESCRIPTION OF THE FIGURES

Preferred embodiments of the invention will now be described with reference to the figures, in which like reference characters denote like elements, by way of example, and in which:

FIG. 1 is a perspective view of the insect container;

FIG. 2 is a perspective view of the insect container of FIG. 1 with a removable lid;

FIG. 3 is a top view of the insect container;

FIG. 4 is a top view of the insect container of FIG. 3 with insects and nutritional components also shown;

FIG. 5 is a side view of the insect container;

FIG. 6A is a side view of the top divider of interlocking dividers;

FIG. 6B is a side view of the bottom divider of interlocking dividers; and

FIGS. 7A to 7D are top views of the insect container showing the insect removal opening of the container aligned over different sections of the insect container.

### DETAILED DESCRIPTION OF PREFERRED EMBODIMENTS

In the claims, the word “comprising” is used in its inclusive sense and does not exclude other elements being present. The indefinite article “a” before a claim feature does not exclude more than one of the feature being present. The phrase “nutritional components” refers to any substance suitable for providing an insect with nourishment for sustaining the insect, such as food and water, and is not limited to any particular kind of food.

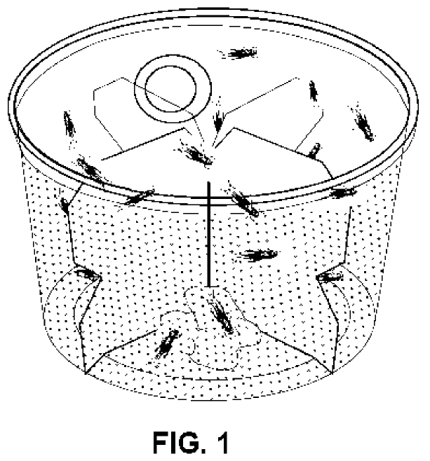

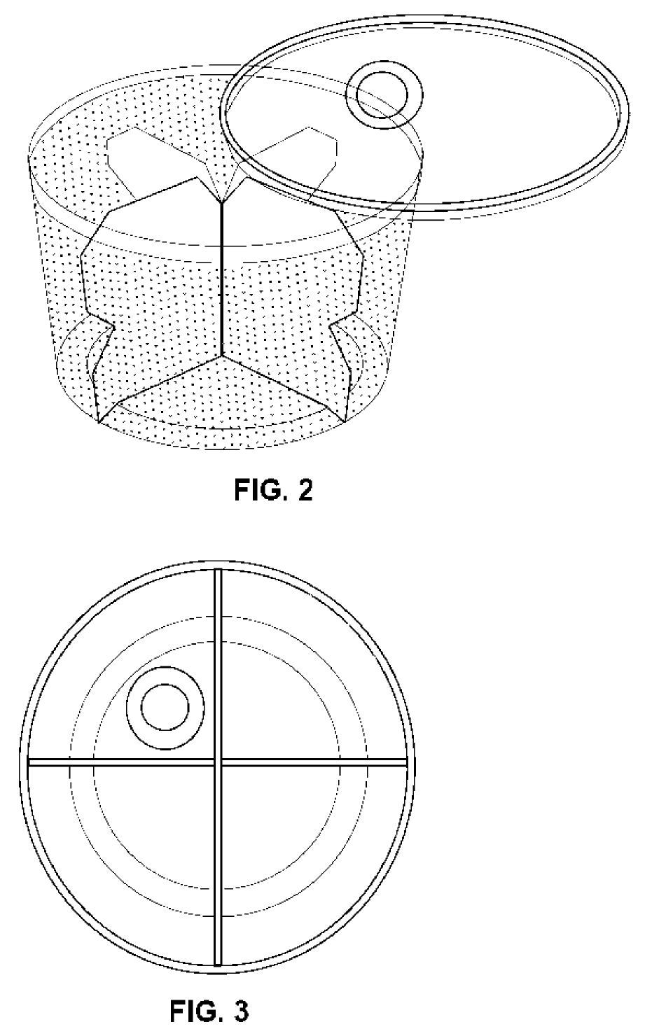

FIG. 1 shows an insect container 10 with a bottom 12, side walls 14, and a top 16. As shown in FIG. 2, the top 16 may be a lid that is removable. The container 10 also has an internal divider 18 that extends between the side walls 14 upwardly from the bottom 12 to form sections 20, as shown in FIG. 3. The internal divider 18 forms a plane along the internal divider 18 from the bottom 12 to the top 14 and has one or more gaps 22 that allow insects 24 to move from one section 20 to another section 20.

A closable insect removal opening 26 with a cover 28 is located on the top 16 of the insect container 10. The insect removal opening 26 has a diameter greater than the girth of the insect 24 to permit the insect 24 to exit the insect container 10 through the insect removal opening 26 of the insect container 10. To prevent any unwanted escape from the insect container 10, the insect removal opening 26 is closable and may have a cover 28 that remains in place over the insect removal opening when the pet owner does not want insects 24 to exit the insect container 10. The cover 28 is preferably made from a transparent material having an adhesive on one side, such as adhesive tape, to allow for repetitive removal and replacement over the insect removal opening 26. It should be understood that the insect removal opening 26 may be closable by other means than a cover 28 as described, provided the insect removal opening 26 remains locatable over any section 20 of the container 10.

As shown in the figures, the insect container 10 preferably has perforations 30 that permit the flow of air into the insect container 10. The perforations 30 also provide traction for crawling insects 24, thus providing a greater surface area on which the crickets 24 may crawl. The perforations 30 allow more insects 24 to be stored in a smaller container than would otherwise be possible if the side walls 14 of the insect container 10 were completely smooth, as would be the case if the insect container 10 were made out of plastic or metal. The perforations 30 also help to reduce the stress on the insects 24, which would otherwise scrabble at the side walls 14 if the side walls 14 were smooth. The perforations 30 are preferably punched into the insect container 10 such that the perforations 30 protrude slightly into the inside of the insect container 10 to make it easier for the insects 24 to climb on the side walls 14. The perforations 30 should be spaced so that the insects 24 can crawl and climb on the side walls 14 without difficulty. If the perforations 30 are spaced too far apart, the insects 24 will not be able to crawl and climb on the side walls 14, in which case, the insects 24 will become crowded on the bottom 12 of the insect container 10 and become more stressed, reducing the longevity and health of the insects 24 within the insect container 10.

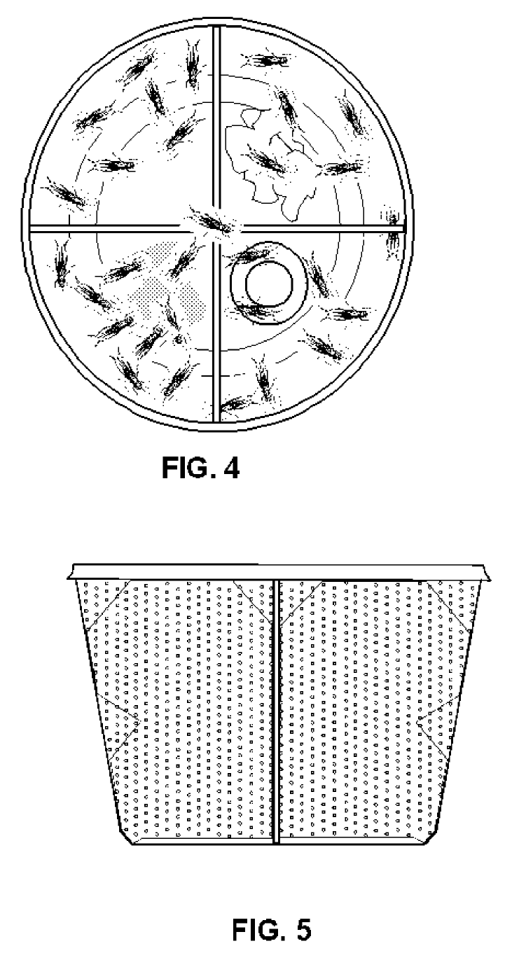

As shown in FIG. 3 and FIG. 4, the internal divider 18 forms four sections 20, or quadrants. It should be understood that the internal divider 18 could be any shape capable of dividing the container 10 into at least two sections 20. Dividing the insect container 10 into sections 20 keeps the nutritional components such as food 32 and water gel 34 separated, which helps to reduce odor in the insect container 10, formation of mold, and spoilage of the food 32. The diameter of the insect removal opening 26 is also preferably wide enough to permit the addition of nutritional components such as food 32 and water gel 34. The water gel 34 may be of the type of crystal readily available in pet stores that, once hydrated, contains adequate moisture for the insects 24. Water gel is also preferred because water gel will not spread throughout the bottom of the container 10 or be absorbed as easily by the internal dividers 18, which otherwise could lead to mold and odor problems. Also, water gel will not drown insects. The food 32 could be any sort of grain, vegetable matter, fruit, or other food suitable for the insects 24. Preferably, the food 32 is dry to prevent the development of mold and to reduce odor coming from the container 10.

The internal divider 18 does not need to extend between the side walls 14 of the container 10 from the bottom 12 of the container 10 to the top 16 of the container 10, though this is preferred. For example, if the internal divider extended upwardly roughly half way up the side walls of the container, the remaining space above the internal divider would form a gap permitting insects to move between sections in the container. However, as shown in a preferred embodiment in FIG. 1, the internal divider 18 divides the container 10 into sections substantially from the bottom 12 to the top 16 of the container 10. This is preferred because the internal divider 18 then provides stability to the container 10 and is less likely to shift inside the container 10. If the internal divider 18 is substantially the full height of the container 10, the internal divider 18 also provides more surface area for insects 24 to crawl on, and also makes it easier for the insects 24 to exit out of the insect removal opening 26 in the top 16 of the insect container 10.

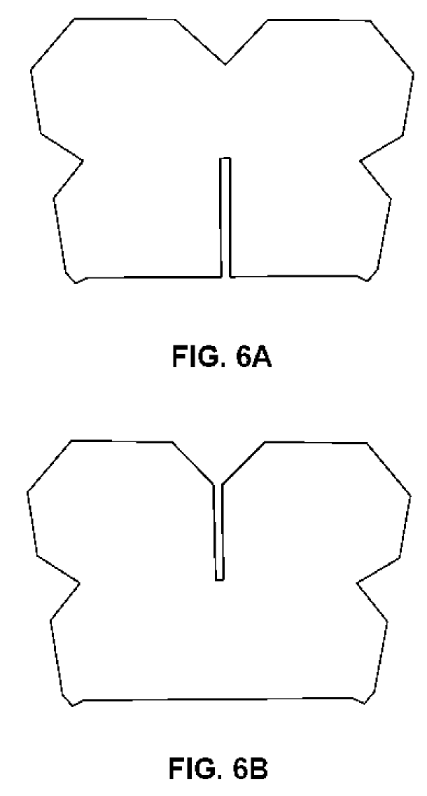

As shown in FIG. 5, the internal divider 18 is preferably a modified X-shape as viewed from the side with triangular-shaped gaps 22 cut from the edges of the internal divider 18. The edges of the internal divider 18 substantially conform to the bottom 12, side walls 14, and top 16 of the internal container 10. As shown in FIGS. 6A and 6B, the internal divider may be formed of two interlocking internal dividers 18A and 18B, in which case slots 36A and 36B may be cut into the internal dividers 18A and 18B, with internal divider 18A fitting on top of internal divider 18B, the internal dividers 18A and 18B being perpendicular to each other once fitted together, as shown in FIGS. 1 and 2.

The internal dividers are preferably made of cardboard because the cardboard provides a slightly textured surface that permits insects 24 to crawl on the side walls of the internal dividers 18, as shown in FIG. 1. Cardboard can also be chewed on by the insects 24, which is preferred, since the cardboard provides the insects 24 with something on which to chew, reducing stress and the likelihood the insects 24 will chew on each other.

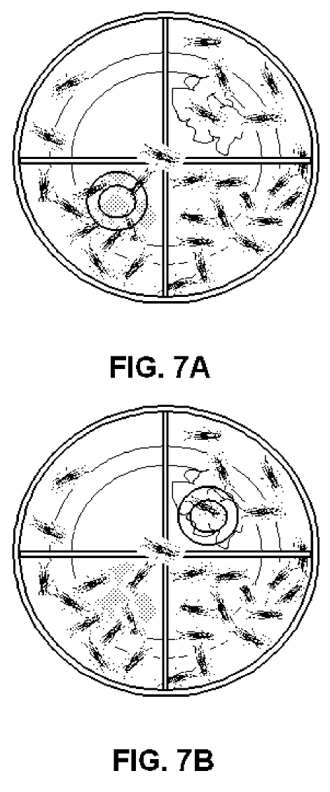

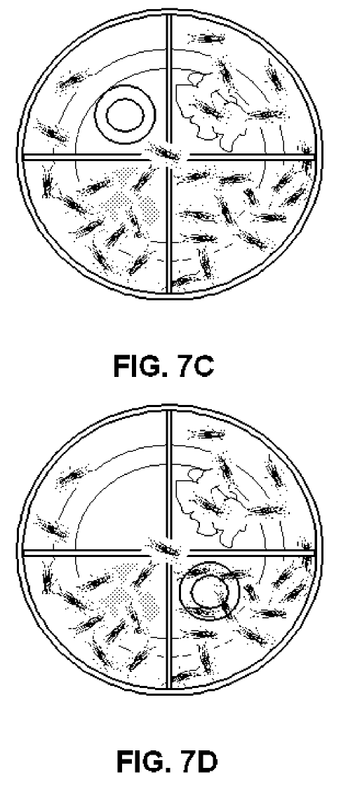

As shown in FIGS. 7A to 7D, the insect removal opening 26 is locatable over any section 20 of the insect container 10. The ability to locate the insect removal opening 26 over any section 20 enables the pet owner to add food 32, as in FIG. 7A or water gel 34, as in FIG. 7B, or to align the insect removal opening 26 above a section 20 containing the desired amount of insects. For example, if only a few insects 24 need to be let out of the insect container 10, the insect removal opening 26 can be aligned over a section with few insects 24, as in FIG. 7C. If a number of insects 24 need to be let out of the container, the insect removal opening 26 can be aligned over a section with numerous insects 24, as in FIG. 7D. It should be understood that the cover 28 needs to be removed from the insect removal opening 26 to add nutritional components or allow insects 24 to exit from the insect container 10.

The insect container 10 is preferably made out of plastic and is transparent. Plastic cannot be chewed through by the insects 24, and if the container 10 is made out of a transparent material, the pet store operator or the pet owner can easily assess the health and vitality of the insects 24. Some insects, such as crickets, prefer conditions with reduced light. Therefore, if a completely transparent plastic is used, it is preferable to keep the insect container 10 out of direct sunlight. It would be possible to make the insect container 10 out of an opaque or translucent plastic material for the bottom 12 and side walls 14, and a top 16 or lid made out of transparent plastic, for example, if some light reduction were deemed more desirable. However, the more opaque the material becomes, the more difficult it is for the pet store operator or pet owner to assess the health and vitality of the insects, as well as the location of the insects within the container.

The insect container may be any size suitable for the purpose. If the insect container 10 is intended to house crickets, for example, a 500 mL, or 16 oz., container has been found suitable for 25 to 50 crickets, and a 1 L, or 32 oz., container has been found suitable for 75 to 100 crickets. It should also be understood that the insect container may be any shape, but a generally cylindrical shape is preferred. Also, the insect container may be made out of any suitable material, but plastic is preferred.

The insect container provides a housing for insects from the time the insects leave the supplier to the time they are fed to a household pet. The insect container makes it easier and more economical for the pet store operator to stock and sell insects. The pet store operator no longer has to provide a bin for storing the insects, or otherwise be much concerned with maintaining the insects prior to purchase. The insect container permits the supplier to ship the insects in the container as a prepackaged, self-contained, and self-sustaining source of pet food. The pet store operator also does not need to worry about having insects escape into the pet store. Also, a clerk is no longer required to remove insects for the pet owner buying insects, thus reducing a possible economic loss to the pet store operator and helping him to better regulate his inventory of insects, since a simple count of insect containers will give a fairly accurate total of insects still in stock.

The insect container also makes it easier and more convenient for the pet owner to keep the insects from the point of purchase to the time when the insects are fed to his pet. The pet owner can simply take an insect container from the pet store shelf to purchase and take the insect container with insects home. Insects in the insect container can be kept alive easily for up to a week, and if it is necessary to keep the insects alive longer, food and water gel or other nourishment can be added as required to the insect container to keep the insects alive until required for pet food.

Immaterial modifications may be made to the embodiments of the invention described here without departing from the invention.

1-2. (canceled)

3. An insect container comprising:
a bottom, a top and an encircling side wall connecting the bottom to the top;
an internal divider for dividing the container into sections, the internal divider having a gap for permitting movement of an insect from section to section;
perforations in the side wall, the perforations having a spacing to provide traction for the insect to permit crawling and climbing by the insect on the side wall; and
a closable insect removal opening in the top, the closable insect removal opening being locatable over any section of the container.

4. The insect container of claim 3 in which the insect removal opening permits the addition of nutritional components to the container.

5. The insect container of claim 3 in which the internal divider partitions the container into three or more sections and for each pair of adjacent sections the internal divider includes an insect crawlway communicating between the pair of adjacent sections.

6. The insect container of claim 3 in which the internal divider extends within the encircling side wall upwardly from the bottom of the container.

7. The insect container of claim 3 in which the container is made of plastic.

8. The insect container of claim 7 in which the container is transparent.

9. The insect container of claim 3 in which the divider is made of cardboard.

10. The insect container of claim 3 used for storing live insects.

11. The insect container of claim 3 used for shipping live insects.

12. The insect container of claim 3 used for selling live insects.

13. (canceled)

14. An insect container, comprising:
a bottom, a top and an encircling side wall connecting between the bottom and the top;
internal dividing walls separating the container into three or more sections;
each internal dividing wall separating a pair of adjacent sections;
an insect crawlway in each internal dividing wall communicating between the adjacent sections separated by the respective internal dividing wall; and
an insect removal opening included in the top of the container that is locatable over any one of the sections of the container.

15. The insect container of claim 14 further comprising perforations in the encircling side wall, the perforations having a spacing to provide traction for an insect to permit crawling and climbing by the insect on the encircling side wall.

16. The insect container of claim 14 in which the top comprises a removable lid.

17. The insect container of claim 14 in which the internal dividing walls extend from the bottom to the top of the container.

18. An insect container, comprising:
a bottom, a top and encircling side wall connecting between the bottom and the top, the bottom of the container being impervious to insects;
internal dividing walls separating the container into three or more sections, the internal dividing walls extending between the top and the bottom of the container;
each internal dividing wall separating a pair of adjacent sections; and
the top incorporating a closable opening that is locatable over any one of the sections.

19. The insect container of claim 18 further comprising an insect crawlway in each internal dividing wall communicating between the adjacent sections separated by the respective internal dividing wall.

20. The insect container of claim 18 in which the encircling side wall has perforations to provide traction and ventilation for insects.

21. The insect container of claim 3 in which the top is rotatable in relation to the encircling side wall to allow positioning of the closable opening over any of the sections.

22. The insect container of claim 14 in which the top is rotatable in relation to the encircling side wall to allow positioning of the closable opening over any of the sections.

23. The insect container of claim 18 in which the top is rotatable in relation to the encircling side wall to allow positioning of the closable opening over any of the sections.
